(19) United States
(12) Patent Application Publication
(10) Pub. No.: US 2016/0285859 A1
(43) Pub. Date: Sep. 29, 2016

(54) METHOD AND DEVICE FOR ACCESSING WEBPAGE

(71) Applicant: LEMOBILE INFORMATION TECHNOLOGY (BEIJING) CO., LTD., Beijing (CN)

(72) Inventors: Shaopeng YU, Beijing (CN); Fan LIANG, Beijing (CN)

(21) Appl. No.: 15/033,578

(22) PCT Filed: Oct. 22, 2014
(86) PCT No.: PCT/CN2014/089197

§ 371 Date: Apr. 29, 2016

(30) Foreign Application Priority Data
Oct. 30, 2013 (CN) 201310530194.1

(51) Int. Cl. H04L 29/06; G06F 17/27; H04N 21/441; H04N 21/4782; H04N 21/45; H04N 21/475; H04L 29/08; G06F 17/30

(52) U.S. Cl. CPC H04L 63/0815; H04L 67/02; G06F 17/2705; G06F 17/3089; H04N 21/4782; H04N 21/4532; H04N 21/4753; H04N 21/441

(57) ABSTRACT

Disclosed are method and device for accessing webpage, applicable to smart television. After a user signs on to the smart television, if it is the first time for the user to sign on to the target website, then, when signing on to the target website, the single sign-on connection relation will be established between the user information for the user to sign on to the smart television and the target website. With the establishment of the single sign-on connection relation, when the user accesses to the target website again with the smart television signed-on, the website signed-on state is directly entered on the basis of the single sign-on connection established with the website without signing on again. And when the user accesses to the website with the smart television unsigned-on, the single sign-on connection established with the website by the historical user can be deleted. Therefore, simple operation can be provided while the security of the user account is ensured and the user experience is improved.

The present disclosure is a national stage of International Application No. PCT/CN2014/089197, filed Oct. 22, 2014, which claims priority from Chinese Patent Application No. 201310530194.1, titled “METHOD AND DEVICE FOR ACCESSING WEBPAGE”, filed on Oct. 30, 2013 in the Chinese Intellectual Property Office, the contents of which in its entirety are herein incorporated by reference.

### FIELD OF TECHNOLOGY

The present disclosure generally relates to the field of smart television, and in particular to a method and a device for accessing webpage.

### BACKGROUND

Television is most common household electrical appliances in modern society. With the development of sciences and technologies, smart television having a full-open platform and provided with an operating system has emerged. A user can install and uninstall various applications by himself or herself while enjoying general television programs through the smart television, so that functions of the smart television can be continuously extended and updated to provide abundant and personalized experience for the user.

At present, the smart television has entered a Terminal Age. The user could login to the smart television and set applications of the smart television under a personal smart television account, thereby improving personalized experience.

Since websites used by the applications installed by the user are increased, the user may have applied for accounts in most of the websites. In the state of the art, however, even through identical accounts and passwords are used in mutually trusted applications and websites, after the login to the smart television is completed, there is a need for the user to login to the websites again and repeatedly. When the account of websites is requested to log off, it is necessary to log off the accounts and the passwords one by one. Therefore, the process is complicated and the user experience is deteriorated.

### SUMMARY

In light of this, one of objectives of the present disclosure is to provide a method and device for accessing webpage, which is able to realize a single sign-on and sign-out via a smart television, thereby simplifying the operations and improving the user experience.

A method for accessing webpage, applicable to a smart television, includes steps of:

receiving a request message of a user requesting for sign-on to a webpage of a target web site;

parsing the request message to acquire the target website and the webpage;

searching for the presence of current user information submitted to sign on to the smart television when the user accesses to the webpage of the target website;

if it is present, searching for the presence of historical user information, wherein if not, which means it is the first time for the current user to sign on, acquiring the current user information, signing on to the target website, establishing a single sign-on connection relation with the target website on the basis of the current user information, and opening the webpage in a signed-on state,

if yes, acquiring the single sign-on connection relation established between the historical user information and the target web site, signing on to the target website on the basis of the single sign-on connection relation, and opening the webpage in the signed-on state; and

if it is not present, deleting historical single sign-on connection relation, signing out the single sign-on connection state, and opening the webpage in a signed-out state.

According to above method, in an embodiment of the present disclosure, the step of establishing a single sign-on connection relation with the target website on the basis of the current user information, includes:

in the process of signing on to the target web site, making an interaction of the current user information with a target website server to acquire sign-on information for signing on to the target web site; and

storing the sign-on information and establishing the single sign-on connection relation with the target web site.

According to above method, in an embodiment of the present disclosure, after searching for the presence of historical user information, and before acquiring the single sign-on connection relation established between the historical user information and the target website, the method further includes:

acquiring the historical user information and the current user information;

judging whether the current user information is identical to the historical user information, wherein

if yes, proceeding to the step of acquiring the single sign-on connection relation established between the historical user information and the target website;

otherwise, signing on to the target website on the basis of the current user information, establishing a new single sign-on connection relation with the target website on the basis of the current user information in place of the historical single sign-on connection relation established between the historical user information and the target website, and opening the webpage in the signed-on state.

According to above method, in an embodiment of the present disclosure, the step of establishing a new single sign-on connection relation with the target website on the basis of the current user information in place of the historical single sign-on connection relation established between the historical user information and the target website, includes:

making an interaction of the current user information with the target website server to acquire the sign-on information for signing on to the target website on the basis of the current user information; and

storing the sign-on information for the current user to sign on to the target website to replace the historical sign-on information for signing on to the target website on the basis of the historical user information, and establishing the new single sign-on connection relation between the current user information and the target website.

According to above method, in an embodiment of the present disclosure, the step of deleting the historical single sign-on connection relation, includes:

deleting the historical sign-on information when signing on to the target website on the basis of the corresponding historical user information, to disconnect the historical single sign-on connection relation established between the historical user information and the target website.

According to above method, in an embodiment of the present disclosure, the sign-on information refers to data cookie stored in a local user terminal.

A device for accessing webpage, applicable to a smart television, includes: a receiving module, a parsing module, a first searching module, a second searching module, a connection establishing module, a single sign-on module, a sign-out module and a storing module, wherein

the receiving module is configured to receive a request message of a user requesting for sign-on to a webpage of a target website;

the parsing module is configured to parse the request message to acquire the target website and the webpage;

the first searching module is configured to search for the presence of current user information submitted to sign on to the smart television when the user accesses to the webpage of the target website, wherein if it is present, then trigger the second searching module; if it is not present, trigger the sign-out module;

the second searching module is configured to search for the presence of historical user information, wherein if not, which means that it is the first time for the current user to sign on, then trigger the connection establishing module; otherwise, trigger the single sign-on module;

the connection establishing module is configured to acquire the current user information, sign on to the target website, establish a single sign-on connection relation with the target website on the basis of the current user information, and open the webpage in the signed-on state;

the single sign-on module is configured to acquire the single sign-on connection relation established between the historical user information and the target website, sign on the target website on the basis of the single sign-on connection relation and open the webpage in the signed-on state;

the sign-out module is configured to delete historical single sign-on connection relation, sign out the single sign-on connection state, and open the webpage in a signed-out state; and

the storing module is configured to store the current user information and/or the historical user information.

According to above device, in an embodiment of the present disclosure, the connection establishing module includes:

a first acquiring module, configured to acquire the current user information and sign on to the target web site;

a second acquiring module, configured to make an interaction of the user information with the target website server to acquire sign-on information for signing on to the target website, in the process of signing on to the target web site; and

a connecting module, configured to store the sign-on information and establish the single sign-on connection relation with the target website.

According to above device, in an embodiment of the present disclosure, the device further includes: an acquiring module, a judging module and a replacing module, wherein

the acquiring module is configured to acquire the historical user information and the current user information;

the judging module is configured to judge whether the current user information is identical to the historical user information, wherein if yes, then trigger the single sign-on module; otherwise trigger the replacing module; and

the replacing module is configured to sign on to the target website on the basis of the current user information, establish a new single sign-on connection relation with the target website on the basis of the current user information in place of the historical single sign-on connection relation established between the historical user information and the target website, and open the webpage in the signed-on state.

According to above device, in an embodiment of the present disclosure, the replacing module includes:

a third acquiring module, configured to make an interaction of the current user information with the target website server to acquire sign-on information for signing on to the target website on the basis of the current user information; and

a connection replacing module, configured to store the sign-on information for the current user to sign on to the target website, replace the historical sign-on information for signing on to the target website on the basis of the historical user information, and establish a new single sign-on connection between the current user information and the target website.

A non-transitory computer readable recording medium, having computer programs stored thereon that, when executed by one or more processors of an electronic apparatus, cause the electronic apparatus to perform:

receiving a request message of a user requesting for sign-on to a webpage of a target web site;

parsing the request message to acquire the target website and the webpage;

searching for the presence of current user information submitted to sign on to the smart television when the user accesses to the webpage of the target website;

if it is present, searching for the presence of historical user information, wherein if not, which means it is the first time for the current user to sign on, acquiring the current user information, signing on to the target website, establishing a single sign-on connection relation with the target website on the basis of the current user information, and opening the webpage in a signed-on state,

if yes, acquiring the single sign-on connection relation established between the historical user information and the target web site, signing on to the target website on the basis of the single sign-on connection relation, and opening the webpage in the signed-on state; and

if it is not present, deleting historical single sign-on connection relation, signing out the single sign-on connection state, and opening the webpage in a signed-out state.

There is further provided a smart television for accessing webpage, characterized in that, the smart television comprises:

a memory having instructions stored thereon;

a processor configured to execute the instructions to perform operations for accessing webpage, comprising:

receiving a request message of a user requesting for sign-on to a webpage of a target web site;

parsing the request message to acquire the target website and the webpage;

searching for the presence of current user information submitted to sign on to the smart television when the user accesses to the webpage of the target website, wherein if it is present, then triggering the second searching module; if it is not present, trigger the sign-out module;

searching for the presence of historical user information, wherein if not, which means that it is the first time for the current user to sign on, then triggering the connection establishing module; otherwise, triggering the single sign-on module;

acquiring the current user information, signing on to the target website, establishing a single sign-on connection relation with the target website on the basis of the current user information, and opening the webpage in the signed-on state;

acquiring the single sign-on connection relation established between the historical user information and the target website, signing on the target website on the basis of the single sign-on connection relation and opening the webpage in the signed-on state;

deleting historical single sign-on connection relation, signing out the single sign-on connection state, and opening the webpage in a signed-out state; and

storing the current user information and/or the historical user information.

There are provided method and device for accessing webpage in the present disclosure. After a user signs on to the smart television, if it is the first time for the user to sign on to the target website, then, when signing on to the target website, the single sign-on connection relation will be established between the user information for the user to sign on to the smart television and the target website. With the establishment of the single sign-on connection relation, when the user accesses to the target website again with the smart television signed-on, the website signed-on state is directly entered on the basis of the single sign-on connection established with the website without signing on again. And when the user accesses to the website with the smart television unsigned-on, the single sign-on connection established with the website by the historical user can be deleted. Therefore, simple operation can be provided while the security of the user account is ensured and the user experience is improved.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow chart of a method for accessing webpage according to an embodiment of the present disclosure;

FIG. 2 is a flow chart of a method for accessing webpage according to another embodiment of the present disclosure;

FIG. 3 is a flow chart of a method for accessing webpage according to another embodiment of the present disclosure;

FIG. 4 is a flow chart of a method for accessing webpage according to another embodiment of the present disclosure;

FIG. 5 is a block diagram of a device for accessing webpage according to an embodiment of the present disclosure;

FIG. 6 is a block diagram of a device for accessing webpage according to another embodiment of the present disclosure;

FIG. 7 is a block diagram of a device for accessing webpage according to another second embodiment of the present disclosure;

FIG. 8 is a block diagram of a device for accessing webpage according to another second embodiment of the present disclosure;

FIG. 9 is a flow chart of an application scenario of the method for accessing webpage according to the present disclosure;

FIG. 10 is a schematic diagram showing a display page of a smart television in an application scenario of the method for accessing webpage according to the present disclosure;

FIG. 11 is a schematic diagram showing another display page of a smart television in an application scenario of the method for accessing webpage according to the present disclosure;

FIG. 12 is a schematic diagram showing another display page of a smart television in an application scenario of the method for accessing webpage according to the present disclosure;

FIG. 13 is a schematic diagram showing another display page of a smart television in an application scenario of the method for accessing webpage according to the present disclosure;

FIG. 14 is a flow chart of another application scenario of the method for accessing webpage according to the present disclosure;

FIG. 15 is a flow chart of another application scenario of the method for accessing webpage according to the present disclosure;

FIG. 16 is a schematic diagram showing a display page of a smart television in another application scenario of the method for accessing webpage according to the present disclosure; and

FIG. 17 is a schematic diagram showing another display page of a smart television in another application scenario of the method for accessing webpage according to the present disclosure.

### DESCRIPTION OF THE EMBODIMENTS

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

A method and a device for accessing webpage in the present disclosure are all applicable to a smart television, for signing on to websites in a browser of the smart.

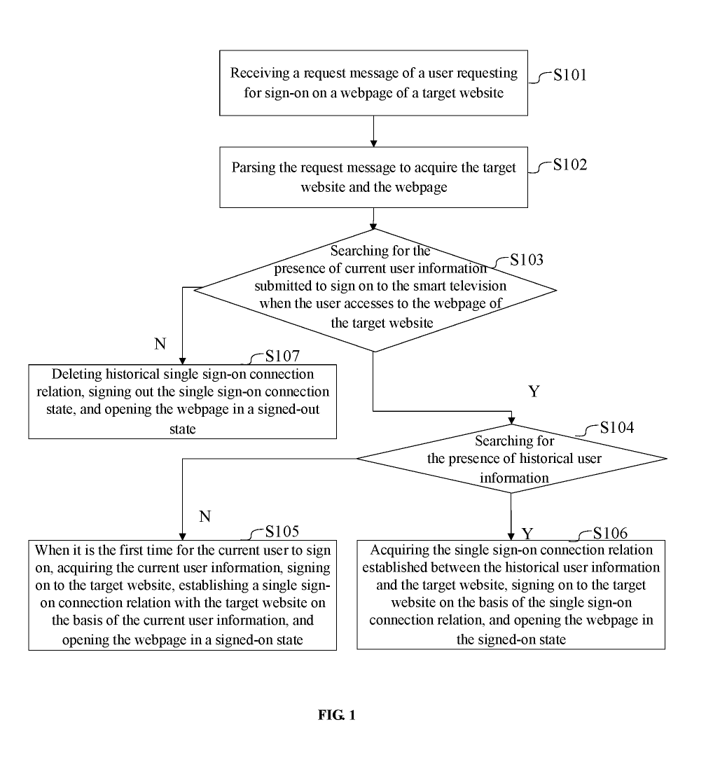

With reference to FIG. 1, a flow chart of a method for accessing webpage according to an embodiment of the present disclosure may include steps of:

Step S101: receiving a request message of a user requesting for sign-on to a webpage of a target website.

The user opens a browser to view the webpage on the smart television. When the user would like to sign on to a website (which is a target website) on a webpage thereof, the user may send the request message for signing on to the target website. The request message can be received to start subsequent sign-on processes.

Step S102: parsing the request message to acquire the target website and the webpage.

The request message can be parsed to acquire the target website and the webpage where the current user is located.

Step S103: searching for the presence of current user information submitted to sign on to the smart television when the user accesses to the webpage of the target website, wherein if it is present, then proceeding to Step S104; otherwise, proceeding to Step S107.

It can be judged whether the user is currently in a signed-on state of the smart television account. The detailed processes thereof are as follows: when the user accesses to the webpage of the target web site, judging whether the current user information submitted to sign on to the smart television by the user is present; if the current user information is present, which means that the user has signed on to the smart television account, then proceeding to Step S104; if the current user information is not present, which means that the user has not signed on to the smart television account, then proceeding to Step S107.

Step S104: searching for the presence of historical user information, if not, then proceeding to Step S105; if yes, then proceeding to Step S106.

If the user has signed on to the smart television account when requesting for signing on to the target website, then it can be judged whether it is the first time for the user to sign on to the smart television. The detailed processes thereof are as follows: searching for the presence of the historical user information, wherein if there is no historical user information, which means that it is the first time for the user to sign on, then proceeding to Step S105; otherwise it is not the first time, then proceeding to Step S106.

Step S105: when it is the first time for the current user to sign on, acquiring the current user information, signing on to the target website, establishing a single sign-on connection relation with the target website on the basis of the current user information, and opening the webpage in a signed-on state.

When the sign-on as requested by the user is a sign-on to the target website for the first time, there is a need to establish the single sign-on connection relation between the user information of the smart television and the target website. The detailed processes thereof are as follows: acquiring the current user information, signing on to the target website on the basis of the current user information, establishing the single sign-on connection relation between the user information of the smart television and the target website, and re-opening the webpage in the signed-on state to allow the user to re-browse the webpage of the website in the signed-on state.

The single sign-on connection relation is equivalent to a connection route between the user of smart television and the target website. After the user signs on to the smart television, the route is automatically in connection to automatically sign on to the target website, without signing on to the target website again for the user.

Step S106: acquiring the single sign-on connection relation established between the historical user information and the target website, signing on to the target website on the basis of the single sign-on connection relation, and opening the webpage in the signed-on state.

When the sign-on as requested by the user is not to sign on to the target website, the historical user information is current sign-on information and the user would sign on according to the single sign-on connection relation between the historical user information and the target website. The detailed processes thereof are as follows: acquiring the single sign-on connection relation established between the historical user information and the target website and directly signing on to the target website on the basis of the single sign-on connection relation without entering information such as account and password again.

And the webpage is re-opened in the signed-on state, such that the user can re-browse the webpage of the website in the signed-on state.

Step S107: deleting historical single sign-on connection relation, signing out the single sign-on connection state, and opening the webpage in a signed-out state.

It can be judged the presence of the current user information submitted to sign on to the smart television by the user when the user accesses to the webpage of the target web site. If the current user information is not present, it will mean that the user has not signed on to the smart television account while the user is requesting for the sign-on of the target website. In order to keep the historical user information safe, at this point, the historical single sign-on connection relation corresponding to the historical user information will be deleted, and the single sign-on connection state of the historical user will be signed out such that the user can open the webpage in the signed-out state.

The user can enter account and password on the sign-on page of the web site to sign on.

There is provided the method for accessing webpage in this embodiment. With such a method, after the user signs on to the smart television, if it is the first time for the user to sign on to the target website, then, when signing on to the target website, the single sign-on connection relation will be established between the user information for the user to sign on to the smart television and the target website. With the establishment of the single sign-on connection relation, when the user accesses to the target website again with the smart television signed-on, the website signed-on state is directly entered on the basis of the single sign-on connection established with the website without signing on again. And when the user accesses to the website with the smart television unsigned-on, the single sign-on connection established with the website by the historical user can be deleted. Therefore, simple operation can be provided while the security of the user account is ensured and the user experience is improved.

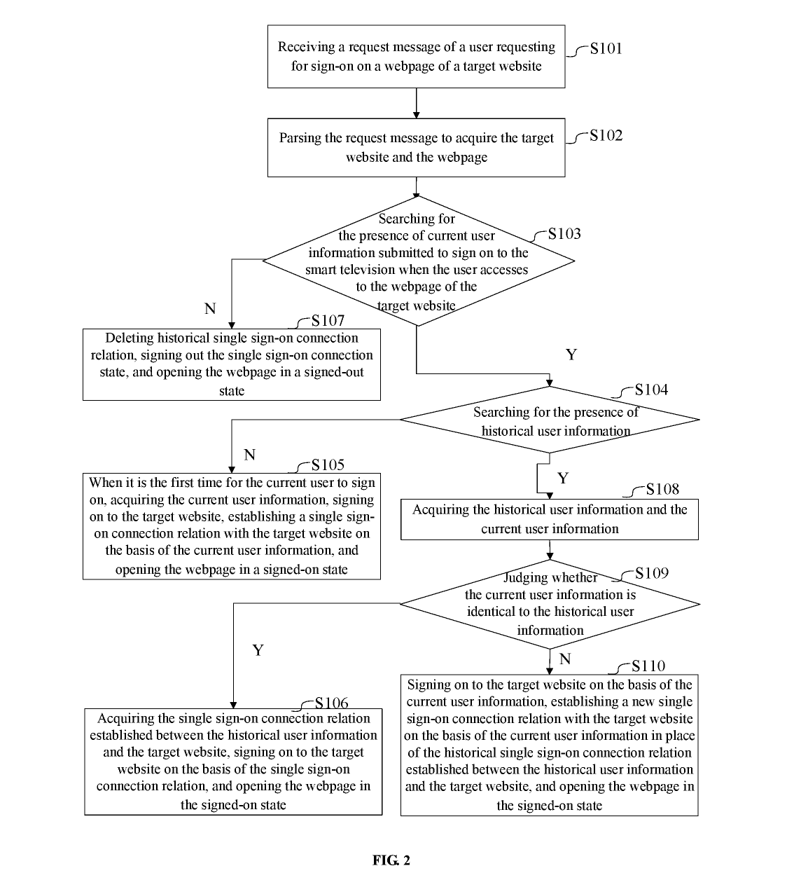

With reference to FIG. 2, it shows a flow chart of a method for accessing webpage according to another embodiment of the present disclosure. In the flow chart as shown in FIG. 1, following steps are included between Step S104 and Step S106:

Step S108: acquiring the historical user information and the current user information.

In practical implementation, for one smart television, two or more users may sign on to the smart television. In other words, one smart television may correspond to information of a plurality of users to sign on. When a user is signing on to a website with the smart television signed-on, user information which was used to sign on to the website before needs to be deleted to keep the website sign-on account of the previous user safe. Therefore, when the historical user information is detected, it is necessary to judge whether the historical user information and the current user information belong to the information of the same user. Therefore, it is necessary to first acquire the historical user information and the current user information for subsequent comparison and judgment.

Step S109: judging whether the current user information is identical to the historical user information, wherein if yes, proceeding to Step S106; otherwise, proceeding to Step S110.

In order to keep the website user accounts safe, the historical user information and the current user information are compared for judgment. If they are identical, which means that the previous user who signed on to the smart television is the same as the current user who is signing on to the smart television, then the sign-on to the website will be completed directly on the basis of the single sign-on connection relation established between the historical user information of the user and the target website, thereby simplifying the process of signing on to the website on the smart television for the user and improving user experience.

Step S110: signing on to the target website on the basis of the current user information, establishing a new single sign-on connection relation with the target website on the basis of the current user information in place of the historical single sign-on connection relation established between the historical user information and the target website, and opening the webpage in the signed-on state.

If the historical user information is not identical to the current user information upon comparison and judgment, which means that the previous user who signed on to the smart television is not the same as the current user who is signing on to the smart television, then the sign-on to the website will be completed on the basis of the current user information. In addition, in the signing-on process, in order to ensure the security of the website account of the user who signed on to the smart television before, it is necessary to delete the information of the user who signed on to the website before to keep the website account for the previous user's sign-on safe. Then, as default, the current user could be regarded as a new user, and a new single sign-on connection relation is established between the current user information and the target website in place of the historical single sign-on connection relation established between the historical user information and the target website.

Then the webpage is re-opened in the signed-on state of the current user, such that the user could re-browse the webpage of the website in the signed-on state.

The method for accessing webpage provided in this embodiment may further include: acquiring the historical user information and the current user information; judging whether the current user information is identical to the historical user information, wherein if yes, proceeding to the step of acquiring the single sign-on connection relation established between the historical user information and the target website; otherwise, establishing a new single sign-on connection relation with the target website on the basis of the current user information in place of the historical single sign-on connection relation established between the historical user information and the target website, signing on to the target website on the basis of the current user information, and opening the webpage in the signed-on state. With such a method, when the current user is the user who signed on to the target website before, the website can be entered directly in the signed-on state without signing on and inputting password again, thereby providing simple operation; by contrast, when the current user is not the user who signed on to the target website before, the single sign-on connection relation between the current user information and the target website can be established in place of the historical single sign-on connection relation, thereby ensuring the security of the user account and improving the user experience.

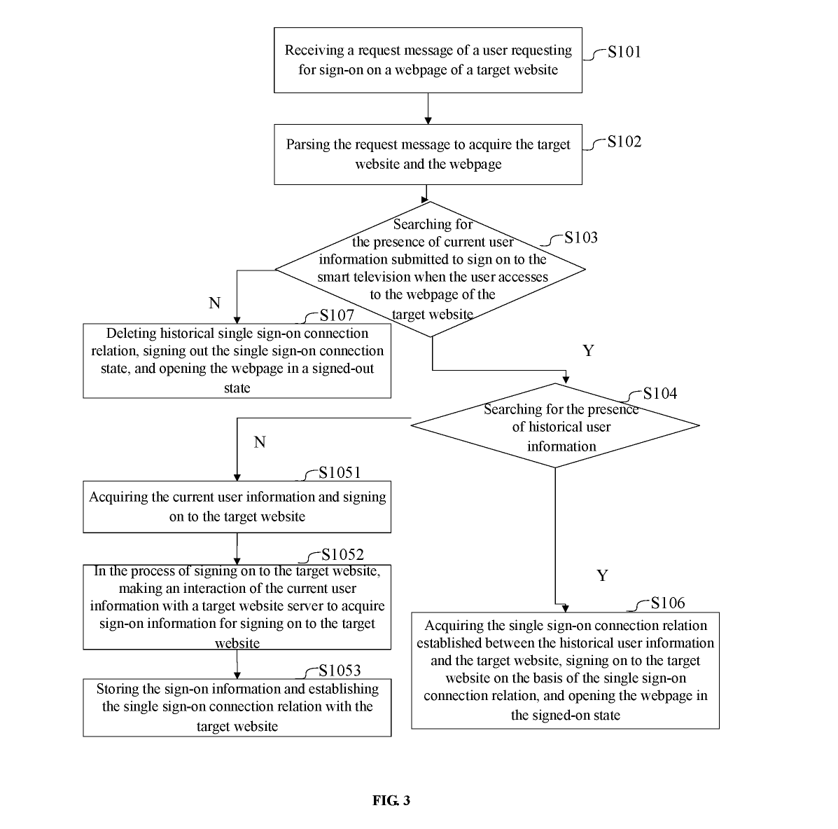

With reference to FIG. 3, it shows a flow chart of a method for accessing webpage according to another embodiment of the present disclosure. In the flow chart as shown in FIG. 1, Step S105 may include:

Step S1051: acquiring the current user information and signing on to the target web site.

When it is judged that it is the first time for the current user to sign on to the smart television, then the step of acquiring the current user information and signing on to the target website will be executed. In practical operation, the current user information can be used as sign-on information for signing on to the target website, or the user may set the sign-on information for signing on to the target website as necessary.

Step S1052: in the process of signing on to the target website, making an interaction of the current user information with a target website server to acquire sign-on information for signing on to the target website.

When the user is signing on to the target website, the current user information for the user to sign on to the smart television is interacted with the target website server. The interactive process can allow user to sign on to the target website to acquire the sign-on information for signing on to the target website. In practical implementation, the sign-on information refers to data cookie stored in a local user terminal. Then the cookie is acquired.

Step S1053: storing the sign-on information and establishing the single sign-on connection relation with the target website.

The storage of the sign-on information, in practical implementation, can be considered to put the cookie into a cookie pool of the browser to establish the single sign-on connection relation between the user information and the target website. On the basis of the connection relation, when the user opens the target website with the smart television signed-on next time, an automatic sign-on to the target website can be completed, such that the user could browse the webpage of the website directly in the signed-on state without entering information such as account and password for sign-on, thereby simplifying the sign-on process and improving the user experience.

Correspondingly to the aforesaid process of establishing the single sign-on connection relation with the target website on the basis of the current user information, the process of deleting historical single sign-on connection relation may include: deleting the historical sign-on information when signing on to the target website on the basis of the corresponding historical user information, to disconnect the historical single sign-on connection relation established between the historical user information and the target website.

The sign-on information refers to cookie. Then, the deletion of the historical sign-on information means that the cookie corresponding to the historical user information is deleted from the cookie pool.

There is provided the method for accessing webpage in this embodiment, in which the single sign-on connection relation is established with the target website on the basis of the current user information. The detailed processes thereof may include: in the process of signing on to the target website, making an interaction of the current user information with a target website server to acquire sign-on information for signing on to the target website; and storing the sign-on information and establishing the single sign-on connection relation with the target website. By processing the sign-on information cookie, it is possible to establish the single sign-on connection relation between the user information and the target website. The implementation procedure is simple and practical.

With reference to FIG. 4, it shows a flow chart of a method for accessing webpage according to another embodiment of the present disclosure. In the flow chart as shown in FIG. 2, Step S110 may include:

Step S1101: making an interaction of the current user information with the target website server to acquire the sign-on information for signing on to the target website on the basis of the current user information.

If the historical user information is not identical to the current user information upon comparison and judgment, which means that the previous user who signed on to the smart television is not the same as the current user who is signing on to the smart television, then the sign-on to the website will be completed on the basis of the current user information.

When the user is signing on to the target website, the current user information for the user to sign on to the smart television is interacted with the target website server. The interactive process can allow user to sign on to the target website to acquire the sign-on information for signing on to the target website. In practical implementation, the sign-on information refers to cookie. Then the cookie is acquired.

Step S1102: storing the sign-on information for the current user to sign on to the target website to replace the historical sign-on information for signing on to the target website on the basis of the historical user information, and establishing the new single sign-on connection relation between the current user information and the target website.

The storage of the sign-on information, in practical implementation, can be considered to put the cookie into the cookie pool to establish the single sign-on connection relation between the user information and the target website. On the basis of the connection relation, when the user opens the target website with the smart television signed-on next time, an automatic sign-on to the target web site can be completed, such that the user could browse the webpage of the website directly in the signed-on state without entering information such as account and password for sign-on, thereby simplifying the sign-on process.

In order to ensure the security of the website account of the user who signed on to the smart television before, it is necessary to delete the information of the user who signed on to the website before to keep the website account for the user's sign-on safe. The process of deleting the historical sign-on information when signing on to the target website which corresponds to the historical user information to disconnect the historical single sign-on connection relation established between the historical user information and the target website, may particularly include: the deletion of the historical sign-on information means that the cookie corresponding to the historical user information is deleted from the cookie pool.

There is provided the method for accessing webpage in this embodiment, in which a new single sign-on connection relation is established with the target website on the basis of the current user information to replace the historical single sign-on connection relation established between the historical user information and the target website. The processes thereof may include: making an interaction of the current user information with the target website server to acquire the sign-on information for signing on to the target website on the basis of the current user information; and storing the sign-on information for the current user to sign on to the target website to replace the historical sign-on information for signing on to the target website on the basis of the historical user information, and establishing a new single sign-on connection relation between the current user information and the target website. By processing the sign-on information cookie, it is possible to establish the single sign-on connection relation between the current user information and the target website to replace the historical single sign-on connection relation between the historical user information and the target website. Therefore, the account security of the smart television user can be ensured while the implementation procedure is simple and practical.

The present disclosure also provides a computer readable recording medium in which a program configured to execute above methods is recorded.

The computer readable recording medium may include any mechanism for storing or transmitting information in a readable form of a computing device (e.g., a computer). For example, the machine readable medium includes Read Only Memory (ROM), Random Access Memory (RAM), magnetic disk storage medium, optical storage medium, flash memory medium, and propagation signals (e.g., carrier wave, infrared signals, digital signals, etc.) in the forms of electrics, optics, acoustics or any other forms.

Correspondingly to the embodiments of the method for accessing webpage, there is also provided the embodiments of the device for accessing webpage in the specification of the present disclosure.

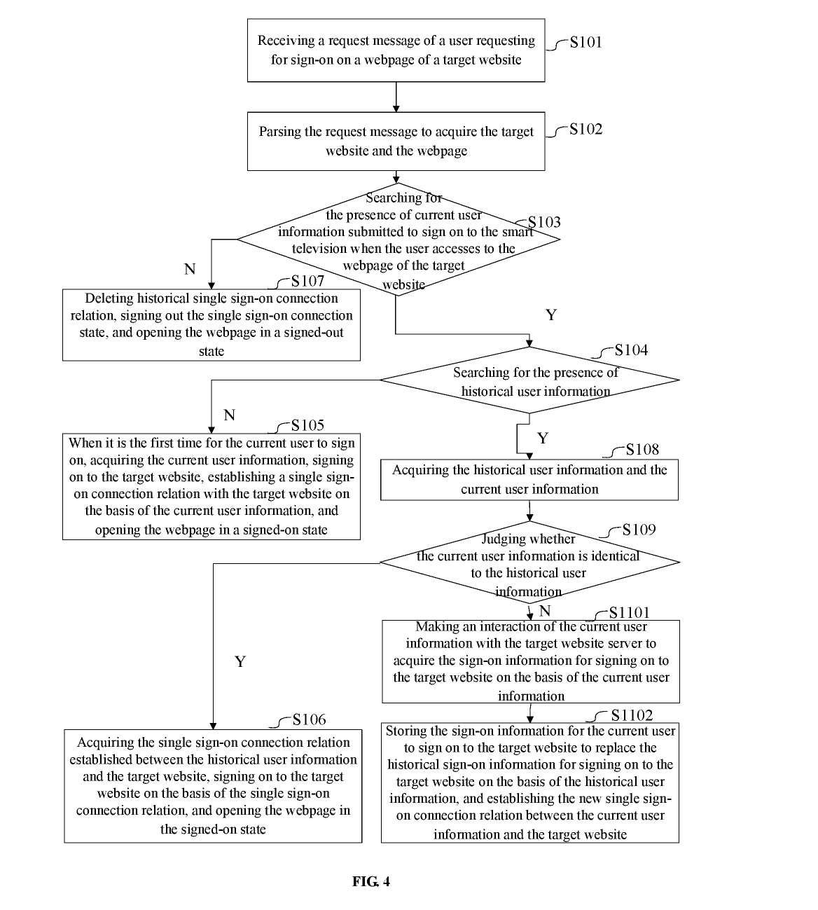

With reference to FIG. 5, it shows a block diagram of a device for accessing webpage according to an embodiment of the present disclosure. The device may include: a receiving module 101, a parsing module 102, a first searching module 103, a second searching module 104, a connection establishing module 105, a single sign-on module 106, a sign-out module 107 and a storing module 108.

Herein, the receiving module 101 is configured to receive a request message of a user requesting for sign-on to a webpage of a target website.

The user opens a browser to view the webpage on the smart television. When the user would like to sign on to a website (which is a target website) on a webpage thereof, the user may send the request message for signing on to the target website. Then the receiving module 101 can receive the request message to start subsequent sign-on processes.

Herein, the parsing module 102 is configured to parse the request message to acquire the target website and the webpage.

The parsing module 102 can parse the request message to acquire the target website and the webpage where the current user is located.

Herein, the first searching module 103 is configured to search for the presence of current user information submitted to sign on to the smart television when the user accesses to the webpage of the target web site, wherein if it is present, then trigger the second searching module 104; otherwise, trigger the sign-out module 107.

The first searching module 103 can search the storing module 108 for the current user information. The current user information is user information submitted to sign on to the smart television when the user accesses to the webpage of the target website. On the basis of whether the user information is detected, it is possible to judge whether the user is currently in a signed-on state of the smart television account. If the current user information is present, which means that the user has signed on to the smart television account, then the second searching module 104 will be triggered; if the current user information is not present, which means that the user has not signed on to the smart television account, then the sign-out module 107 will be triggered.

Herein, the second searching module 104 is configured to search for the presence of historical user information, wherein if not, which means that it is the first time for the current user to sign on, then trigger the connection establishing module 105; otherwise, trigger the single sign-on module 106.

If the user has signed on to the smart television account when requesting for signing on to the target website, the second searching module 104 can search the storing module 108 for the historical user information. The historical user information is user information submitted when the previous user signed on to the smart television. On the basis of whether the historical user information is detected, it is possible to judge whether it is the first time for the user to sign on to the smart television. If there is no historical user information, which can indicate that the user is signing on for the first time, then the connection establishing module 105 will be triggered; otherwise, the user is not signing on for the first time and then the single sign-on module 106 will be triggered.

Herein, the connection establishing module 105 is configured to acquire the current user information, sign on to the target website, establish a single sign-on connection relation with the target website on the basis of the current user information, and open the webpage in the signed-on state.

When the sign-on as requested by the user is a sign-on to the target website for the first time, there is a need to establish the single sign-on connection relation between the user information of the smart television and the target website. The detailed processes thereof are as follows: the connection establishing module 105 can acquire the current user information, sign on to the target website on the basis of the current user information, establish the single sign-on connection relation between the user information of the smart television and the target website, and re-open the webpage in the signed-on state to allow the user to re-browse the webpage of the website in the signed-on state.

The single sign-on connection relation is equivalent to a connection route between the user of smart television and the target website. After the user signs on to the smart television, the route is automatically in connection to automatically sign on to the target website, without signing on to the target website again for the user.

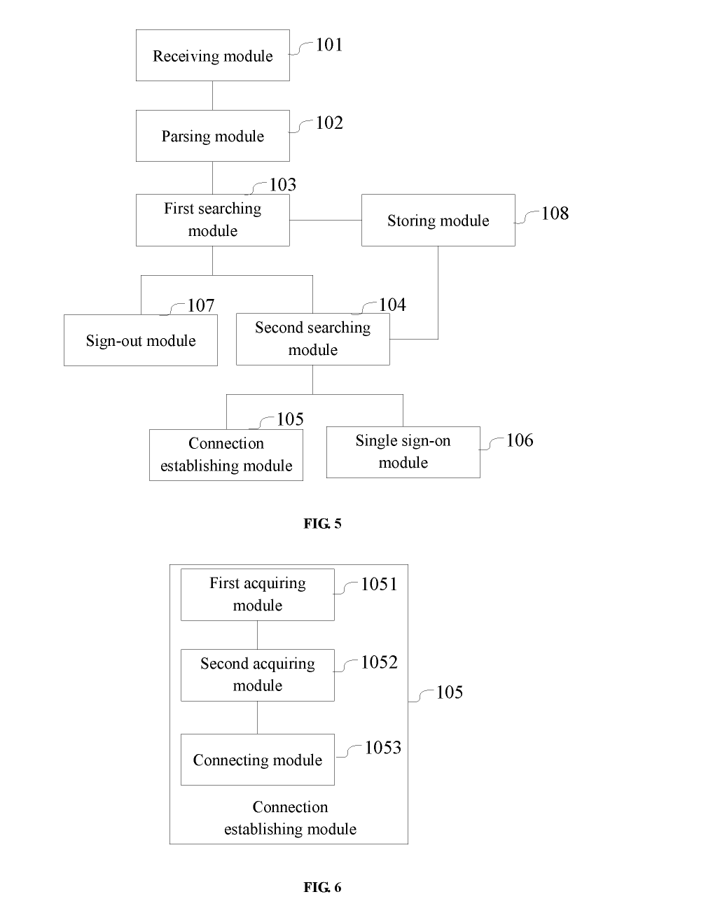

A specific block diagram is shown in FIG. 6. In the structure as shown in FIG. 5, the connection establishing module 105 may include: a first acquiring module 1051, a second acquiring module 1052 and a connecting module 1053.

Herein, the first acquiring module 1051 is configured to acquire the current user information and sign on to the target website.

When it is judged that it is the first time for the current user to sign on to the smart television, the first acquiring module 1051 will acquire the current user information and sign on to the target website. In practical operation, the current user information can be used as sign-on information for signing on to the target website, or the user may set the sign-on information for signing on to the target website as necessary.

Herein, the second acquiring module 1052 is configured to make an interaction of the user information with the target website server to acquire sign-on information for signing on to the target website, in the process of signing on to the target website.

When the user is signing on to the target website, the current user information for the user to sign on to the smart television is interacted with the target website server. The interactive process can allow user to sign on to the target website, and the second acquiring module 1052 can acquire the sign-on information for signing on to the target website. In practical implementation, the sign-on information refers to data cookie stored in a local user terminal. Then the cookie is acquired.

Herein, the connecting module 1053 is configured to store the sign-on information and establish the single sign-on connection relation with the target website.

The connecting module 1053 can store the sign-on information. In practical implementation, the cookie can be put into a cookie pool of the browser. The connecting module 1053 can establish the single sign-on connection relation between the user information and the target website. On the basis of the connection relation, when the user opens the target website with the smart television signed-on next time, an automatic sign-on to the target website can be completed, such that the user could browse the webpage of the web site directly in the signed-on state without entering information such as account and password for sign-on, thereby simplifying the sign-on process and improving the user experience.

Herein, the single sign-on module 106 is configured to acquire the single sign-on connection relation established between the historical user information and the target website, sign on the target website on the basis of the single sign-on connection relation and open the webpage in the signed-on state.

When the sign-on as requested by the user is not to sign on to the target website, the historical user information is current sign-on information and the user would sign on according to the single sign-on connection relation between the historical user information and the target website. The detailed processes thereof are as follows: the single sign-on module 106 can acquire the single sign-on connection relation established between the historical user information and the target website and directly sign on to the target website on the basis of the single sign-on connection relation without entering information such as account and password again.

And the webpage is re-opened in the signed-on state, such that the user can re-browse the webpage of the website in the signed-on state.

Herein, the sign-out module 107 is configured to delete historical single sign-on connection relation, sign out the single sign-on connection state, and open the webpage in a signed-out state.

It can be judged the presence of the current user information submitted to sign on to the smart television by the user when the user accesses to the webpage of the target web site. If the current user information is not present, it will mean that the user has not signed on to the smart television account while the user is requesting for the sign-on of the target website. In order to keep the historical user information safe, at this point, the sign-out module 107 can delete the historical single sign-on connection relation corresponding to the historical user information, and sign out the single sign-on connection state of the historical user such that the user can open the webpage in the signed-out state.

The user can enter account and password on the sign-on page of the website to sign on.

Correspondingly to the aforesaid process of establishing the single sign-on connection relation with the target website on the basis of the current user information, the process of deleting historical single sign-on connection relation may include: deleting the historical sign-on information when signing on to the target website on the basis of the corresponding historical user information, to disconnect the historical single sign-on connection relation established between the historical user information and the target website.

The sign-on information refers to cookie. Then, the deletion of the historical sign-on information means that the cookie corresponding to the historical user information is deleted from the cookie pool.

There is provided the device for accessing webpage in this embodiment. With such a device, after the user signs on to the smart television, if it is the first time for the user to sign on to the target website, then, when signing on to the target website, the single sign-on connection relation is established between the user information for the user to sign on to the smart television and the target website. With the establishment of the single sign-on connection relation, when the user accesses to the target website again with the smart television signed-on, the website signed-on state is directly entered on the basis of the single sign-on connection established with the website without signing on again. And when the user accesses to the website with the smart television unsigned-on, the single sign-on connection established with the website by the historical user is deleted. Therefore, simple operation can be provided while the security of the user account is ensured and the user experience is improved.

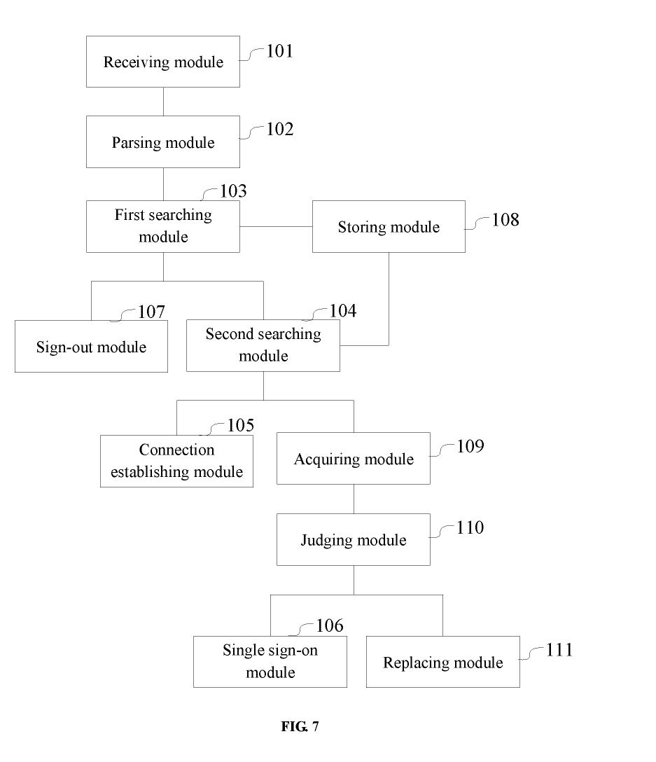

With reference to FIG. 7, it shows a block diagram of a device for accessing webpage according to another embodiment of the present disclosure. The device as shown in FIG. 5 may further include: an acquiring module 109, a judging module 110 and a replacing module 111.

Herein, the acquiring module 109 is configured to acquire the historical user information and the current user information.

In practical implementation, for one smart television, two or more users may sign on to the smart television. In other words, one smart television may correspond to information of a plurality of users to sign on. When a user is signing on to a website with the smart television signed-on, user information which was used to sign on to the website before needs to be deleted to keep the website sign-on account of the previous user safe. Therefore, when the historical user information is detected, it is necessary to judge whether the historical user information and the current user information belong to the information of the same user. First the acquiring module 109 is required to acquire the historical user information and the current user information for subsequent comparison and judgment.

Herein, the judging module 110 is configured to judge whether the current user information is identical to the historical user information, wherein if yes, then trigger the single sign-on module 106; otherwise, trigger the replacing module 111.

In order to keep the website user accounts safe, the historical user information and the current user information are compared for judgment. If they are identical, which means that the previous user who signed on to the smart television is the same as the current user who is signing on to the smart television, the single sign-on module 106 will be triggered to directly sign on to the website on the basis of the single sign-on connection relation established between the historical user information of the user and the target website, thereby simplifying the process of signing on to the website on the smart television for the user and improving user experience.

Herein, the replacing module 111 is configured to sign on to the target website on the basis of the current user information, establish a new single sign-on connection relation with the target website on the basis of the current user information in place of the historical single sign-on connection relation established between the historical user information and the target website, and open the webpage in the signed-on state.

If the historical user information is not identical to the current user information upon comparison and judgment of the judging module 110, which means that the previous user who signed on to the smart television is not the same as the current user who is signing on to the smart television, then the replacing module 111 can sign on to the target website on the basis of the current user information. In addition, in the signing-on process, in order to ensure the security of the website account of the user who signed on to the smart television before, it is necessary to delete the information of the user who signed on to the website before to keep the website account for the previous user's sign-on safe. Then, as default, the current user could be regarded as a new user, and the replacing module 111 can establish a new single sign-on connection relation between the current user information and the target website in place of the historical single sign-on connection relation established between the historical user information and the target website.

Then the webpage is re-opened in the signed-on state of the current user, such that the user could re-browse the webpage of the website in the signed-on state.

A specific block diagram is shown in FIG. 8. In the structure as shown in FIG. 7, the replacing module 111 may include following modules.

Herein, a third acquiring module 1111 is configured to make an interaction of the current user information with the target website server to acquire sign-on information for signing on to the target website on the basis of the current user information.

If the historical user information is not identical to the current user information upon comparison and judgment, which means that the previous user who signed on to the smart television is not the same as the current user who is signing on to the smart television, then the sign-on to the website will be completed on the basis of the current user information.

When the user is signing on to the target website, the third acquiring module 1111 can make an interaction of the current user information for the user to sign on to the smart television with the target website server. The interactive process can allow user to sign on to the target website to acquire the sign-on information for signing on to the target website. In practical implementation, the sign-on information refers to cookie. Then the cookie is acquired.

Herein, a connection replacing module 1112 is configured to store the sign-on information for the current user to sign on to the target website, replace the historical sign-on information for signing on to the target website on the basis of the historical user information, and establish a new single sign-on connection between the current user information and the target website.

The connection replacing module 1112 can store the sign-on information, which, in practical implementation, can be considered to put the cookie into the cookie pool to establish the single sign-on connection relation between the user information and the target website. On the basis of the connection relation, when the user opens the target website with the smart television signed-on next time, an automatic sign-on to the target website can be completed, such that the user could browse the webpage of the website directly in the signed-on state without entering information such as account and password for sign-on, thereby simplifying the sign-on process.

In order to ensure the security of the web site account of the user who signed on to the smart television before, it is necessary to delete the information of the user who signed on to the website before to keep the website account for the user's sign-on safe. The connection replacing module 1112 can delete the historical sign-on information when signing on to the target website which corresponds to the historical user information to disconnect the historical single sign-on connection relation established between the historical user information and the target website. In particular, the deletion of the historical sign-on information means that the cookie corresponding to the historical user information is deleted from the cookie pool.

The device for accessing webpage provided in this embodiment may further include: the acquiring module, configured to acquire the historical user information and the current user information; the judging module, configured to judge whether the current user information is identical to the historical user information, wherein if yes, then trigger the single sign-on module; otherwise trigger the replacing module; the replacing module configured to sign on to the target website on the basis of the current user information, establish a new single sign-on connection relation with the target website on the basis of the current user information in place of the historical single sign-on connection relation established between the historical user information and the target website, and open the webpage in the signed-on state. With such a device, when the current user is the user who signed on to the target website before, the website can be entered directly in the signed-on state without signing on and inputting password again, thereby providing simple operation; by contrast, when the current user is not the user who signed on to the target website before, the single sign-on connection relation between the current user information and the target website can be established in place of the historical single sign-on connection relation, thereby ensuring the security of the user account and improving the user experience.

Specific application scenarios of the method and device for accessing webpage in practical application are provided in the present disclosure.

One Application Scenario

In this application scenario, the user accesses to the target webpage while he or she signs on to the smart television for the first time.

As shown in FIG. 9, specific processes of the application scenario may include following steps.

Step S201: user signing on to an account A of a smart television.

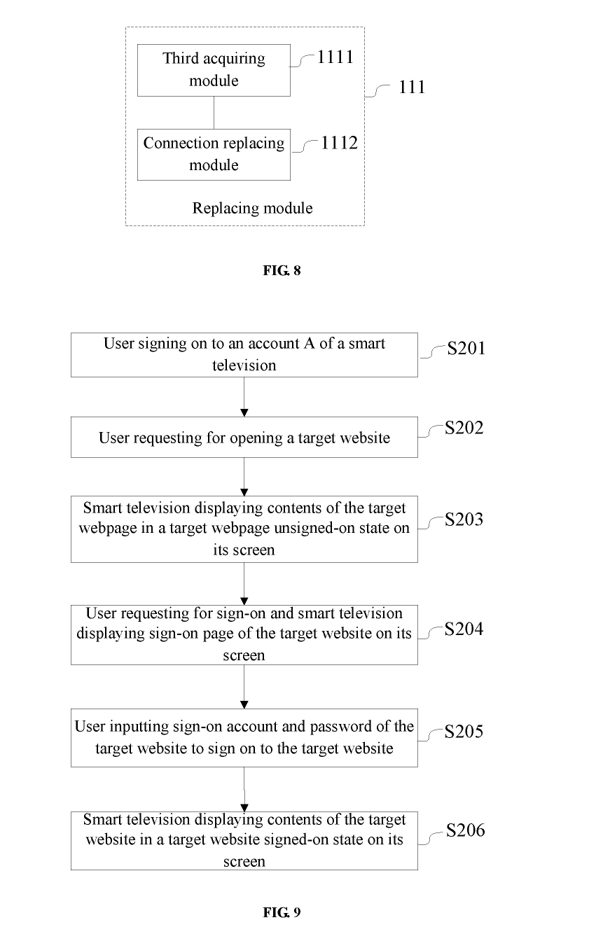

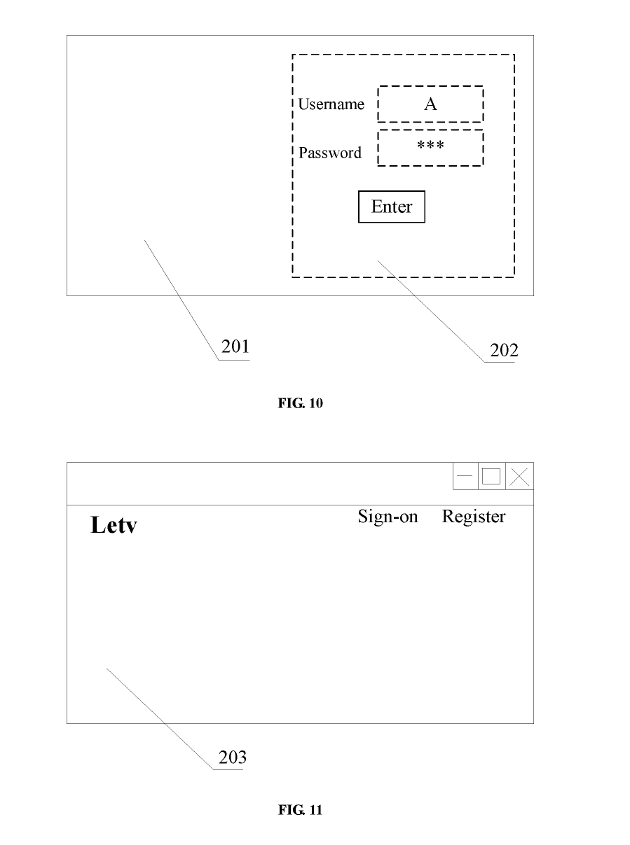

FIG. 10 shows a schematic diagram of a display page of the smart television. The user can sign a smart television account on a sign-on area 202 of the display page 201 of the smart television. The sign-on area shows “Username” and “Password” and “Enter” buttons. A username “A” is input in a dotted box behind the “Username”, and a password shown as “***” is input in a dotted behind the “Password”.

Step S202: the user requesting for opening a target website.

The user clicks LeTV option on the webpage of the browser, requesting for opening the target website LeTV (www.letv.com).

Step S203: the smart television displaying contents of the target webpage in a target webpage unsigned-on state on its screen.

The webpage of the target website is opened. Since the user has not signed on to the website, the LeTV webpage in the unsigned-on state is displayed on the screen of the smart television. FIG. 11 shows a schematic diagram of another display page of the smart television. The display page 203 is the LeTV webpage in the unsigned-on state. The webpage shows a website name “LeTV” of the target website. At upper-right corner, the webpage shows “Sign-on” and “Register” buttons to inform the user of the unsigned-on state.

Step S204: the user requesting for sign-on and the smart television displaying the sign-on page of the target website on its screen.

The storage area is searched. As a result, the username has not signed on to LeTV, which means it is the first time to sign on to the website. Therefore, the user is invited to sign the sign-on account and password of this website.

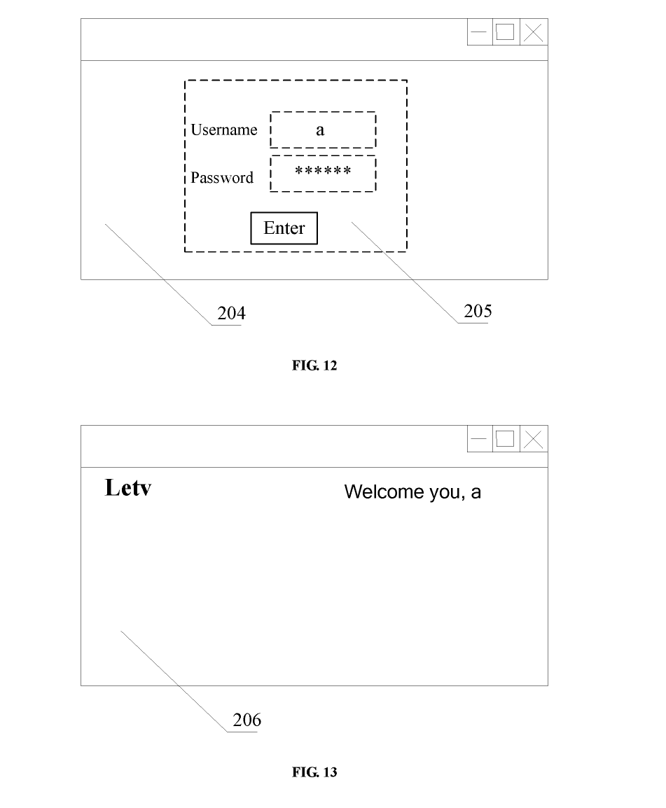

FIG. 12 shows a schematic diagram of another display page of the smart television. The user can sign a target website account on a sign-on area 205 of a display page 204 of the smart television. The sign-on area shows: “LeTV account sign-on”, “Username”, “Password” and “Enter” buttons. A username “a” is input in a dotted box behind the “Username”, and a password shown as “******” is input in a dotted behind the “Password”.

Step S205: the user inputting sign-on account and password of the target website to sign on to the target website.

The user can input the sign-on account and password on the sign-on page to sign on to LeTV.

While the user is signing on to the target website, a single sign-on connection relation between target website LeTV and user information (username A) is established.

Step S206: the smart television displaying contents of the target website in a target website signed-on state on its screen.

FIG. 13 shows a schematic diagram of another display page of the smart television. The opened page 206 displayed on the screen of the smart television indicates the signed-on state and shows “welcome you, a”, wherein “a” is the username of the user in LeTV.

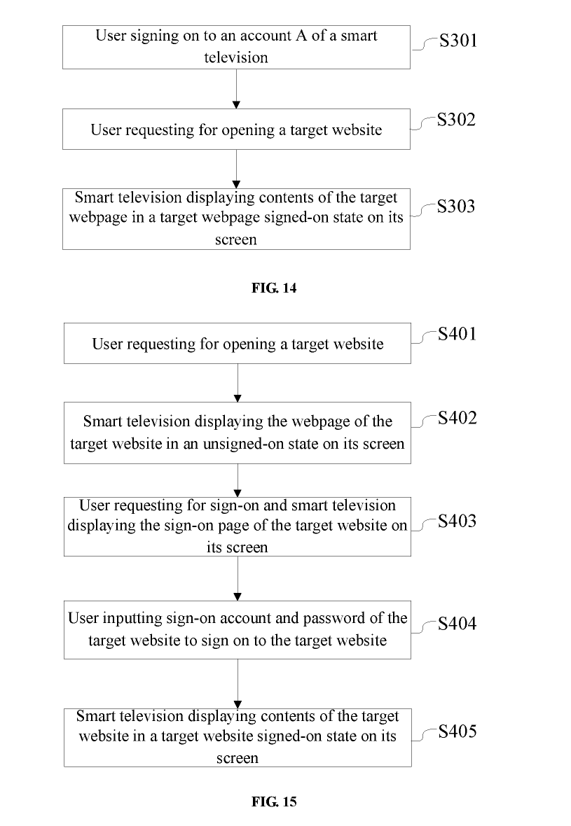

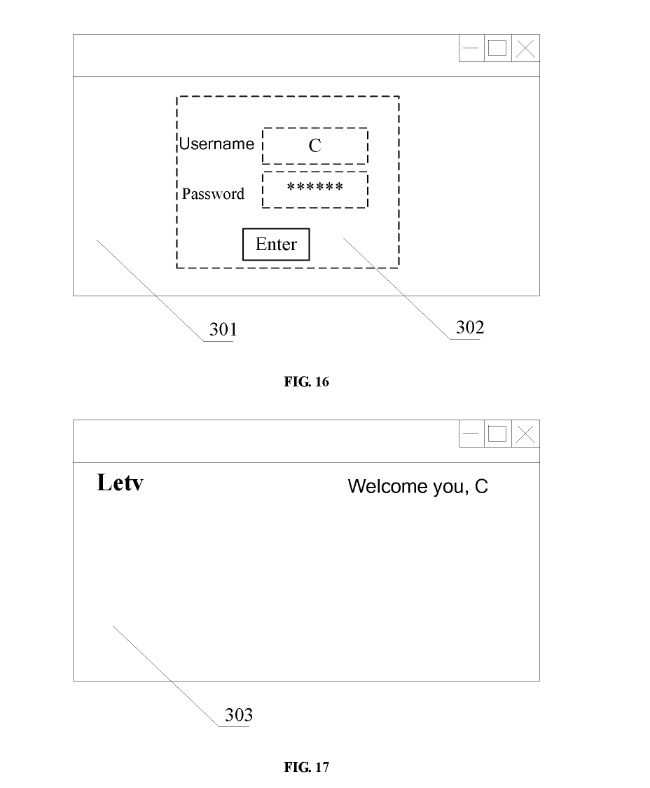

As shown in FIG. 14, specific processes of another application scenario may include following steps.

In this application scenario, the user accesses to the target webpage while it is not the first time for him or she to sign on to the smart television.

Step S301: the user signing on to an account A of a smart television.

Step S302: the user requesting for opening a target website.

Step S303: the smart television displaying contents of the target webpage in a target webpage signed-on state on its screen.

The storage area is searched to judge it is not the first time the user to sign on to the target website. As a result, the user has signed on to LeTV with the username A, which means it is not the first time to sign on to the website. Then it is possible to directly sign on to LeTV on the basis of the single sign-on connection relation between the username and the target web site.

As shown in FIG. 13, the opened page 206 displayed on the screen of the smart television indicates the signed-on state and shows “welcome you, a”, wherein “a” is the username of the user in LeTV.

As shown in FIG. 15, specific processes of another application scenario may include following steps.

In this application scenario, the user accesses to the target webpage while he or she has not signed on to the smart television.

Step S401: the user requesting for opening a target website.

The user clicks LeTV option on the webpage of the browser, requesting for opening the target website LeTV (www.letv.com).

Step S402: the smart television displaying the webpage of the target website in an unsigned-on state on its screen.

The smart television displays the sign-on page of the target website on its screen.

The storage area is searched. As a result, no information of the current user signing on to the smart television is detected, which means that the user of the smart television has not signed on to the smart television and the smart television is in an unsigned-on state.

The webpage of the target website is opened. Since the user has not signed on to the website, the LeTV webpage in the unsigned-on state is displayed on the screen of the smart television. FIG. 11 shows the schematic diagram of the display page of the smart television. The display page 203 is the LeTV webpage in the unsigned-on state. The webpage shows a website name “LeTV” of the target website. At upper-right corner, the webpage shows “Sign-on” and “Register” buttons to inform the user of the unsigned-on state.

Step S403: the user requesting for sign-on and the smart television displaying the sign-on page of the target website on its screen.

The smart television displays the sign-on page of the target website on its screen.

The storage area is searched. As a result, no information of the current user signing on to the smart television, which means the user who is currently using the smart television has not signed on to the smart television and the smart television is in an unsigned-on state. If the user would like to sign on to the website, he or she will be invited to input sign-on account and password of this website for signing on.

Step S404: the user inputting sign-on account and password of the target website to sign on to the target website.

FIG. 1 shows a schematic diagram of another display page of the smart television. The user can sign a target website account on a sign-on area 302 of a display page 301. The sign-on area shows: “LeTV account sign-on”, “Username”, “Password” and “Enter” buttons. A username “C” is input in a dotted box behind the “Username”, and a password shown as “******” is input in a dotted behind the “Password”.

While the user is signing on to the target website, the single sign-on connection relation between the user information of previous user (username A) and the target website LeTV is deleted.

Step S405: the smart television displaying contents of the target website in a target website signed-on state on its screen.

FIG. 17 shows a schematic diagram of another display page of the smart television. The opened page 303 displayed on the screen of the smart television indicates the signed-on state and shows “welcome you, C”, wherein “C” is the username of the user in LeTV.

Although, in the application scenarios provided in the present disclosure, “Welcome you,” displayed on the webpage indicates the user signed-on state, the present disclosure is not limited thereto. In practical implementation, the identification information indicating the signed-on state can be set as practically necessary.

The method and device for accessing webpage according to the present disclosure have been described in detail. Herein the principles and implementations of the present disclosure are illustrated by way of specific examples. The embodiments described above are only intended to help understand the method and main concept of the present disclosure. Meanwhile, for an ordinary skilled person in the art, variations could be made to the specific implementations and their application scope in accordance with concepts of the present disclosure. In summary, the contents of the specification should not be construed as limiting of the present disclosure.

1. A method for accessing webpage, characterized in that, the method is applicable to a smart television and comprises steps of:
receiving a request message of a user requesting for sign-on to a webpage of a target web site;
parsing the request message to acquire the target website and the webpage;
searching for the presence of current user information submitted to sign on to the smart television when the user accesses to the webpage of the target website;
if it is present, searching for the presence of historical user information, wherein if not, which means it is the first time for the current user to sign on, acquiring the current user information, signing on to the target website, establishing a single sign-on connection relation with the target website on the basis of the current user information, and opening the webpage in a signed-on state,
if yes, acquiring the single sign-on connection relation established between the historical user information and the target website, signing on to the target website on the basis of the single sign-on connection relation, and opening the webpage in the signed-on state; and
if it is not present, deleting historical single sign-on connection relation, signing out the single sign-on connection state, and opening the webpage in a signed-out state.

2. The method according to claim 1, characterized in that, the step of establishing a single sign-on connection relation with the target website on the basis of the current user information, comprises:
in the process of signing on to the target website, making an interaction of the current user information with a target website server to acquire sign-on information for signing on to the target website; and
storing the sign-on information and establishing the single sign-on connection relation with the target website.

3. The method according to claim 1, characterized in that, after searching for the presence of historical user information, and before acquiring the single sign-on connection relation established between the historical user information and the target website, the method further comprises:
acquiring the historical user information and the current user information;
judging whether the current user information is identical to the historical user information, wherein
if yes, proceeding to the step of acquiring the single sign-on connection relation established between the historical user information and the target website;
otherwise, signing on to the target website on the basis of the current user information, establishing a new single sign-on connection relation with the target website on the basis of the current user information in place of the historical single sign-on connection relation established between the historical user information and the target website, and opening the webpage in the signed-on state.

4. The method according to claim 3, characterized in that, the step of establishing a new single sign-on connection relation with the target website on the basis of the current user information in place of the historical single sign-on connection relation established between the historical user information and the target website, comprises:
making an interaction of the current user information with the target website server to acquire the sign-on information for signing on to the target website on the basis of the current user information; and
storing the sign-on information for the current user to sign on to the target website to replace the historical sign-on information for signing on to the target website on the basis of the historical user information, and establishing the new single sign-on connection relation between the current user information and the target website.

5. The method according to claim 1, characterized in that, the step of deleting the historical single sign-on connection relation, comprises:
deleting the historical sign-on information when signing on to the target website on the basis of the corresponding historical user information, to disconnect the historical single sign-on connection relation established between the historical user information and the target website.

6. The method according to claim 2, characterized in that, the sign-on information refers to data cookie stored in a local user terminal.

7. A smart television for accessing webpage, characterized in that, the smart television comprises:
a memory having instructions stored thereon;
a processor configured to execute the instructions to perform operations for accessing webpage, comprising:
receiving a request message of a user requesting for sign-on to a webpage of a target website;
parsing the request message to acquire the target website and the webpage;
searching for the presence of current user information submitted to sign on to the smart television when the user accesses to the webpage of the target website, wherein if it is present, then triggering the second searching module; if it is not present, trigger the sign-out module;
searching for the presence of historical user information, wherein if not, which means that it is the first time for the current user to sign on, then triggering the connection establishing module; otherwise, triggering the single sign-on module;
acquiring the current user information, signing on to the target website, establishing a single sign-on connection relation with the target website on the basis of the current user information, and opening the webpage in the signed-on state;
acquiring the single sign-on connection relation established between the historical user information and the target website, signing on the target website on the basis of the single sign-on connection relation and opening the webpage in the signed-on state;
deleting historical single sign-on connection relation, signing out the single sign-on connection state, and opening the webpage in a signed-out state; and
storing the current user information and/or the historical user information.

8. The smart television according to claim 7, characterized in that, the processor is further configured to perform:
acquiring the current user information and signing on to the target website;
making an interaction of the user information with the target website server to acquire sign-on information for signing on to the target website, in the process of signing on to the target website; and
storing the sign-on information and establishing the single sign-on connection relation with the target website.

9. The smart television according to claim 7, characterized in that, the processor is further configured to perform:
acquiring the historical user information and the current user information;
judging whether the current user information is identical to the historical user information, wherein if yes, acquiring the single sign-on connection relation established between the historical user information and the target website, signing on the target website on the basis of the single sign-on connection relation and opening the webpage in the signed-on state; otherwise
signing on to the target website on the basis of the current user information, establishing a new single sign-on connection relation with the target website on the basis of the current user information in place of the historical single sign-on connection relation established between the historical user information and the target website, and opening the webpage in the signed-on state.

10. The smart television according to claim 9, characterized in that, the processor is further configured to perform:
making an interaction of the current user information with the target website server to acquire sign-on information for signing on to the target website on the basis of the current user information; and
storing the sign-on information for the current user to sign on to the target website, replacing the historical sign-on information for signing on to the target website on the basis of the historical user information, and establishing a new single sign-on connection between the current user information and the target website.

11. A non-transitory computer readable recording medium, having computer programs stored thereon that, when executed by one or more processors of an electronic apparatus, cause the electronic apparatus to perform:
receiving a request message of a user requesting for sign-on to a webpage of a target website;
parsing the request message to acquire the target website and the webpage,
searching for the presence of current user information submitted to sign on to the smart television when the user accesses to the webpage of the target website;
if it is present, searching for the presence of historical user information, wherein if not, which means it is the first time for the current user to sign on, acquiring the current user information, signing on to the target website, establishing a single sign-on connection relation with the target website on the basis of the current user information, and opening the webpage in a signed-on state,
if yes, acquiring the single sign-on connection relation established between the historical user information and the target website, signing on to the target website on the basis of the single sign-on connection relation, and opening the webpage in the signed-on state, and
if it is not present, deleting historical single sign-on connection relation, signing out the single sign-on connection state, and opening the webpage in a signed-out state.
